(19) United States
(12) Patent Application Publication
(10) Pub. No.: US 2012/0095164 A1
(43) Pub. Date: Apr. 19, 2012

(54) CROSSLINKABLE POLYURETHANE DISPERSIONS

(75) Inventors: Harald Blum, Hafenlohr (DE); Heino Müller, Leverkusen (DE); Sebastian Dörr, Duesseldorf (DE)

(73) Assignee: BAYER MATERIALSCIENCE AG, Leverkusen (DE)

(21) Appl. No.: 13/376,800

(22) PCT Filed: Jun. 24, 2010
(86) PCT No.: PCT/EP2010/003884

§ 371 Date: Dec. 30, 2011

(30) Foreign Application Priority Data
Jul. 2, 2009 (EP) 09008659.6

(51) Int. Cl. C09D 175/06; C09J 175/06; C08G 18/66

(52) U.S. Cl. 524/839; 528/83; 528/73

(57) ABSTRACT

The invention relates to novel aqueous, crosslinkable polyurethane dispersions based on terephthalic acid polyesters, the production thereof and their use in combination with hydroxy-functional reactants for the production of lacquers, coatings and sizes which are distinguished especially by high film hardness together with high elasticity and very good adhesion.

The invention relates to novel aqueous crosslinkable polyurethane dispersions based on terephthalic acid polyesters, the production thereof and their use in combination with hydroxy-functional reactants for the production of lacquers, coatings and sizes, which are distinguished primarily by high film hardness together with high elasticity and very good adhesion

Aqueous binders based on polyurethane dispersions or polyester dispersions are known in principle, cf. e.g. Houben-Weyl, Methoden der organischen Chemie, u. edition volume E 20, p. 1659 (1987) or J. W. Rosthauser, K. Nachtkamp in “Advances in Urethane Science and Technology”, K. C. Frisch and D. Klempner, editors, vol. 10, pp. 121-162 (1987), D. Dietrich, K. Uhlig in Ullmann's Encyclopedia of Industrial Chemistry, vol. A 21, p. 677 (1992).

In the past few years, the importance of aqueous lacquers and coating compositions has grown markedly owing to increasingly strict emissions guidelines relating to the solvents released during lacquer application. Although aqueous lacquer systems have meanwhile become available for many areas of application, these often fail to achieve the high quality level of conventional, solvent-based lacquers in terms of solvent and chemical resistance, high film hardness at the same time as high elasticity, combined with very good adhesion.

EP 1 862 486 describes storage-stable polyurethane dispersions with pyrazole-blocked isocyanate groups similar to those obtainable according to EP 942 023, but which are free from or low in solvents and in particular contain no N-methylpyrrolidone or butyl glycol. The coatings produced from these dispersions have a good film appearance and good chemical resistance, but in combination with hydroxy-functional dispersions they generally lead to coatings with pendulum hardnesses according to DIN 53157 in the range of about 80 to 110 seconds. For applications in which, for example, significantly higher hardnesses are required, these products cannot therefore be used. Moreover, improved adhesion values would also be desirable for some applications.

The object of the present invention was therefore to provide crosslinkable, solvent-free polyurethane dispersions which are suitable for the production of high-quality lacquers and coatings with high film hardness together with high elasticity, good film appearance and solvent or chemical resistance and very good adhesion.

Surprisingly, it has been found that specific crosslinkable polyurethane dispersions based on terephthalic acid polyesters, polyisocyanates and blocking agents meet all the requirements very well, and in combination with hydroxy-functional aqueous or water-dilutable reactants they can be cured to form coating compositions with the required level of properties. Moreover, the crosslinkable polyurethane dispersions according to the invention permit the simple production of crosslinkable binder combinations, which additionally exhibit physical drying at room temperature and thus, for example, are less susceptible to negative influences on the surface quality of coatings during and after application, e.g. through the influence of dust particles.

The present invention therefore provides crosslinkable polyurethane dispersions containing
a) at least one hydroxy-functional aromatic polyester with an average OH functionality of 1.5 to 3.5 produced from terephthalic acid,
b) at least one isocyanate-reactive hydrophilising agent having at least one acid group and at least one group which is reactive towards isocyanate groups,
c) at least one, at least bifunctional polyisocyanate and
d) at least one blocking agent which is reactive towards NCO groups.

The invention also provides crosslinkable polyurethane dispersions containing reaction products of
a) 20 to 80 wt. % of at least one hydroxy-functional aromatic polyester with an average OH functionality of 1.75 to 3 produced from terephthalic acid,
b) 0.7 to 9 wt. % of at least one isocyanate-reactive hydrophilising agent, which has at least one acid group and at least one group which is reactive towards isocyanate groups,
c) 15 to 60 wt. % of at least one, at least bifunctional polyisocyanate,
d) 2 to 30 wt. % of at least one blocking agent which is reactive towards NCO groups and
e) 0 to 40 wt. % other components,
   the percentages a) to e) adding up to 100%.

The invention also provides crosslinkable polyurethane dispersions, containing reaction products of
a) 30 to 65 wt. % of at least one hydroxy-functional aromatic polyester with an average OH functionality of 1.75 to 3 produced from terephthalic acid,
b) 1 to 6 wt. % of at least one isocyanate-reactive hydrophilising agent, which has at least one acid group and at least one group which is reactive towards isocyanate groups,
c) 30 to 50 wt. % of at least one, at least bifunctional polyisocyanate,
d) 4 to 18 wt. % of at least one blocking agent which is reactive towards NCO groups and
e) 0 to 30 wt. % other components,
   the percentages a) to e) adding up to 100%.

The invention also provides aqueous binder combinations containing

A) at least one aqueous dispersion, solution, emulsion and/or suspension of a polymer or oligomer, or at least one water-dilutable, water-dispersible and/or water-soluble polymer and/or oligomer and/or monomer, and
B) at least one crosslinkable polyurethane dispersion according to the invention.

The invention also provides aqueous binder combinations containing

A) 40 to 98 wt. % of at least one aqueous dispersion, solution, emulsion and/or suspension of a hydroxy-functional polymer or oligomer, or at least one aqueous or water-dilutable or water-dispersible hydroxy-functional polymer and/or oligomer and/or monomer,
B) 2 to 60 wt. % of at least one crosslinkable polyurethane dispersion according to the invention.

The invention also provides a one-stage process for the production of the crosslinkable polyurethane dispersions according to the invention, wherein all non-isocyanate-functional components are initially added to a solvent, preferably acetone, the isocyanate component is added and the reaction is performed in the optional presence of suitable catalysts, such as e.g. dibutyltin dilaurate, tin-2-octoate, dibutyltin oxide or diazabicyclononane, until all the components are incorporated into the polymer. If not already added, appropriate neutralising agent is then added for salt formation and dispersion takes place by adding water or transferring into an aqueous medium. In parallel or subsequently, the solvent is removed by distillation.

A ratio of isocyanate-reactive groups to isocyanate groups of 1:1 to 1:1.1 is preferably selected here.

It is of course also possible to employ variants of this process, for example the reaction can be carried out in multiple stages, e.g. by first reacting only part of the isocyanate-reactive components with the polyisocyanate component, and in a second reaction step, which can optionally also take place only after dispersing, reacting the remaining isocyanate groups with additional isocyanate-reactive components.

The invention also provides the use of the crosslinkable polyurethane dispersions according to the invention in combination with any aqueous, water-dilutable and/or water-dispersible hydroxy-functional polymers or oligomers for the production of combinations of binders which are stable when stored at room temperature up to at least 40° C., which can be stoved at elevated temperatures, preferably 90 to 180° C., to form high-quality lacquers and coatings or sizes.

The invention also provides the use of the crosslinkable polyurethane dispersions according to the invention for primers, stoving filler coatings, one-coat lacquers, intermediate coat lacquers, base coats, stone impact protection primers, clear lacquers, pigmented lacquers, decorative lacquers, protective lacquers, top coats and sizes of all types.

Suitable hydroxy-functional aromatic polyesters a) can be produced by processes which are known per se with the release of water at temperatures of 100° C. to 260° C., optionally also using conventional esterification catalysts such as e.g. para-toluenesulfonic acid, dibutyltin dilaurate, HCl, tin (II) chloride etc., preferably by the principle of a melt condensation or azeotropic condensation, optionally with the application of a vacuum or use of a carrier gas comprising mono-, di-, tri- and/or tetracarboxylic acids or their anhydrides, mono-, di-, tri- and/or tetrafunctional alcohols and optionally lactones.

In the case of azeotropic esterification of the polyester components, the entrainer, usually isooctane, xylene, toluene or cyclohexane, is distilled off in vacuo on completion of the reaction.

A preferred production process for the polyester a) is a melt condensation under reduced pressure.

The hydroxy-functional aromatic polyesters a) have an average OH functionality of 1.5 to 3.5, preferably of 1.75 to 3 and particularly preferably of 1.9 to 2.75.

It is also possible to use mixtures of different polyesters and also mixtures of polyesters having different functionalities. The incorporation e.g. of polyesters having a functionality of less than 2 into these polyester mixtures is possible in minor quantities.

The polyesters a) have calculated theoretical molecular weights of 500 to 12000 g/mol, preferably of 900 to 3500 g/mol.

The theoretical molecular weight of the polyesters is determined by the formula: mass of batch [g]/(mol COOH+mol OH)-Eq COOH.

The hydroxy-functional, aromatic polyester component a) contains at least one polyester, which is the reaction product of
a1) terephthalic acid and optionally at least one additional aromatic di- and/or tricarboxylic acid or anhydride thereof,
a2) at least one diol,
a3) optionally additional components, such as e.g. triols, tetraols, monofunctional alcohols, monocarboxylic acids, monoepoxides, bisepoxides, polyepoxides, lactones and/or aliphatic or cycloaliphatic di- or tricarboxylic acids or anhydrides thereof,
   wherein the proportion of component a1) in the quantity of component a1) to a3) is at least 38 wt. %, preferably at least 52 wt. %.

Preferred polyester components a) are polyesters with a hydroxyl value of 10 to 230, preferably 48 to 160 mg KOH/g substance, which are reaction products of
a1) 38 to 72 wt. % of a mixture of terephthalic acid and optionally at least one additional aromatic di- and/or tricarboxylic acid or anhydride thereof,
a2) 20 to 55 wt. % of at least one diol,
a3) 0 to 40 wt. % of additional components encompassing triols, tetraols, monofunctional alcohols, monocarboxylic acids, monoepoxides, bisepoxides, polyepoxides, lactones, aliphatic or cycloaliphatic di- or tricarboxylic acids or anhydrides thereof,
   wherein at least 15 wt. %, preferably at least 40% and particularly preferably at least 48% terephthalic acid is contained in the quantity of components a1) used.

Suitable compounds of component a1) encompass terephthalic acid, phthalic anhydride, isophthalic acid, tetrachlorophthalic acid, trimellitic anhydride and pyromellitic anhydride.

Preferred compounds of component a1) are terephthalic acid and mixtures of terephthalic acid with isophthalic acid and/or phthalic anhydride. It is also possible to use the corresponding C1-C4 alkyl esters of terephthalic acid instead of terephthalic acid.

The components a1) consists of at least 15 wt. %, preferably at least 40% and particularly preferably at least 48% terephthalic acid.

Suitable compounds of component a2) encompass ethylene glycol, 1,2-propanediol, 1,3-propanediol, neopentyl glycol, 1,4-butanediol, 1,3-butanediol, 1,2-butanediol, butenediol, butynediol, 1,6-hexanediol, 1,4-cyclohexanedimethanol, 1,4-cyclohexanediol, 2,2-dimethyl-3-hydroxypropionic acid-(2,2-dimethyl-3-hydroxy-propyl ester), diethylene glycol, dipropylene glycol, triethylene glycol, tripropylene glycol, tetraethylene glycol, positional isomeric diethyl octanediols, hydrogenated bisphenols, hydrogenated and ethoxylated bisphenols, ethoxylated pyrocatechol, ethoxylated resorcinol, ethoxylated hydroquinone, ethoxylated and alkyl-substituted hydroquinones, resorcinols and pyrocatechols, 2-methyl-1,3-propanediol, 3-methyl-1,5-pentanediol, trimethyl pentanediol, 1,8-octanediol and/or tricyclodecane-dimethanol and mixtures of the above and optionally also other diols.

Preferred compounds of component a2) are ethylene glycol, 1,2- or 1,3-propanediol, neopentyl glycol, 1,4-butanediol and/or 1,6-hexanediol.

Most particularly preferred as component a2) are mixtures of neopentyl glycol and ethylene glycol

Suitable optionally incorporated components a3) include castor oil, trimethylolpropane, glycerol, pentaerythritol, ε-caprolactone, tetrahydrophthalic anhydride, hexahydrophthalic anhydride, 1,4-cyclohexanedicarboxylic acid, adipic acid, azelaic acid, sebacic acid, glutaric acid, maleic acid (anhydride), fumaric acid, itaconic acid, malonic acid, suberic acid, 2-methylsuccinic acid, 3,3-diethylglutaric acid, 2,2-dimethylsuccinic acid, dimer fatty acids, dimer fatty acid mixtures, monoepoxides, such as e.g. the glycidyl ester of versatic acid, bisepoxides, such as e.g. epoxidised bisphenols, polyepoxides, epoxidised fatty acids or oils, butyl glycol, butanol, pentanol, 2-ethylhexanoic acid, tert.-butylbenzoic acid, benzoic acid, soybean oil fatty acid, oleic acid, stearic acid, C8 to C30 monocarboxylic acids or mixtures thereof. A suitable polyester raw material a3) is also caprolactone, which can be used in proportions for the production of the polyesters a).

It is also possible to incorporate amino- and/or thio-functional compounds, such as e.g. isophorone diamine, hexamethylenediamine, ethylenediamine, butylamine, diethanolamine, diisopropanolamine and diphenylmethanediamine (MDA), into component a3). It is also possible to incorporate ethoxylated or propoxylated alcohols, such as e.g. ethoxylated trimethylolpropane, into component a3).

The acid value of the corresponding polyester component a) is generally 10 to 0.1 mg KOH/g, preferably 5 to 0.5 mg KOH/g.

In component a) it is also possible to use mixtures of two or more polyesters, such as e.g. mixtures of two polyesters which contain terephthalic acid; mixtures of a polyester which contains terephthalic acid with minor quantities of an aromatic/aliphatic polyester, with minor quantities of an aliphatic polyester, with minor quantities of a hydroxy-functional aliphatic polycarbonate, and/or with minor quantities of a hydroxy-functional C2, C3 and/or C4 polyether.

The component a) preferably consists of at least 75 wt. %, particularly preferably 100 wt. %, of a polyester which contains terephthalic acid.

The polyesters used as component a) have melting or softening points of more than −10° C., preferably more than 25° C. and particularly preferably more than 45° C.

The glass transition temperature of the polyesters used as component a) is >5° C., preferably >20° C.

The isocyanate-reactive hydrophilising agents used as component b) consist of at least one (potentially) ionic compound with at least one acid group and at least one group which is reactive towards isocyanate groups. Suitable acid groups are e.g. carboxylic and sulfonic acid groups. Suitable groups which are reactive towards isocyanate groups are e.g. hydroxyl and/or amino groups.

Preferred as component b) are e.g. di- and/or tri- and/or monohydroxycarboxylic acids and/or di- and/or tri- and/or monohydroxysulfonic acids, or di- and/or tri- and/or monoaminosulfonic acids and/or di- and/or tri- and/or monoaminocarboxylic acids.

Particularly preferred components b) are e.g. dimethylolpropionic acid, dimethylolbutyric acid, dimethylolacetic acid, dihydroxysuccinic acid, hydroxypivalic acid, hydroxyacetic acid, hydroxypropionic acid, aminocarboxylic acids, such as e.g. 6-aminohexanoic acid, alanine, aminoundecanoic acid, 8-aminooctanoic acid, 5-aminopentanoic acid, 4-aminobutyric acid, aminobenzoic acid, 5-naphthylamine-1-sulfonic acid, 4-naphthylamine-1-sulfonic acid, 2-naphthylamine-1-sulfonic acid, 5-naphthylamine-2-sulfonic acid, 8-naphthylamine-1-sulfonic acid, 3-naphthylamine-2-sulfonic acid, 4-aminomethylcyclohexane-carboxylic acid, 2-aminohexanoic acid, 4-aminocyclohexanecarboxylic acid, 12-aminododecanoic acid, 9-aminoononacarboxylic acid, Michael addition products of acrylic acid, methacrylic acid, maleic acid, fumaric acid to amines such as e.g. isophorone diamine, butanediamine, ethylenediamine or hexamethylenediamine, sulfonic acid diols having ether groups of the type described in U.S. Pat. No. 4,108,814 or 2-aminoethyl-aminoethanesulfonic acid.

Most particularly preferred components b) are hydroxypivalic acid, 6-aminohexanoic acid and Michael addition products of acrylic acid, methacrylic acid, maleic acid, fumaric acid to amines such as e.g. isophorone diamine, butanediamine, ethylenediamine or hexamethylenediamine, sulfonic acid diols having ether groups of the type described in U.S. Pat. No. 4,108,814, dimethylolpropionic acid and/or 2-aminoethylamino ethanesulfonic acid.

An even more preferred hydrophilising agent is hydroxypivalic acid.

An even more preferred hydrophilising agent is also 6-aminohexanoic acid.

The combination of the preferred isocyanate-reactive hydrophilising agents b) with anhydride-functional hydrophilising agents, such as e.g. trimellitic anhydride, phthalic anhydride, tetrahydrophthalic anhydride, maleic anhydride and/or hexahydrophthalic anhydride, is also preferred.

These anhydrides can be used as component e), it being possible to incorporate the greatest part of the hydrophilising via these anhydrides.

This double hydrophilising leads to particularly high-quality products and permits for example higher solids contents and leads in particular to polyurethane dispersions according to the invention with particularly good film-forming properties, such as flow and body.

Component b) is generally contained in quantities of 0.7 to 9 wt. %, preferably in quantities of 1 to 6 wt. %.

Particularly preferred is the use of 1.7 to 3.4 wt. % hydroxypivalic acid as the sole hydrophilising agent.

The acid values of the crosslinkable polyurethane dispersions according to the invention incorporated via component b) and optionally component e) are 3.5 to 40 mg KOH/g substance, preferably 3.5 to 25 mg KOH/g substance.

These comparatively low acid values have a surprisingly positive effect on the film-appearance properties of corresponding coatings, such as e.g. flow, susceptibility to cratering and achievable film thickness. Surprisingly, even with such low acid values, it has been possible to achieve stable high-quality dispersions without having to use external emulsifiers, stabilisers or surface-active substances.

It is also surprising that, despite the incorporation of relatively large quantities of the hydrophobic aromatic polyester component a), the crosslinkable polyurethane dispersions according to the invention with relatively low contents of hydrophilic groups permit particle sizes of less than 100 nm and at the same time high solids contents of up to 50%.

The free acid groups represent “potentially ionic” groups, while the salt-like groups obtained by neutralisation with neutralising agents, carboxylate or sulfonate groups, are “ionic” groups.

Suitable neutralising agents, which may already be present during the reaction of the components a) to d) or optionally e), are e.g. triethylamine, N-methylmorpholine, dimethylisopropylamine, ethyldiisopropylamine, optionally also potassium hydroxide and/or sodium hydroxide.

It should if appropriate be borne in mind that excessively large quantities of these neutralising agents during the reaction of the components may lead to undesirable secondary reactions, such as e.g. excessive trimerisation of component c).

After complete conversion of components a) to d) or optionally e), other neutralising agents can also be added, either before, during or after the dispersing. Suitable neutralising agents at this point are, in addition to those mentioned above, e.g. dimethylethanolamine, ammonia, lithium hydroxide, morpholine, N-methyldiethanolamine, aminomethyl propanol, triethanolamine, ethanolamine, diethanolamine and/or 2-amino-2-methyl-1-propanol and/or others.

In total, sufficient neutralising agent is added so that the degree of neutralisation based on incorporated acid groups is at least 50%, preferably at least 75% and no more than 150%. With a degree of neutralisation of over 100%, in addition to 100% ionic salt groups, free neutralising amine is also present. Particularly preferred is a degree of neutralisation of 95 to 110%.

It is also possible to use mixtures or combinations of different neutralising agents.

Suitable components c) are any organic compounds that have at least two free isocyanate groups per molecule.

Diisocyanates of the general formula X(NCO)2, wherein X denotes a divalent aliphatic hydrocarbon residue with 4 to 12 carbon atoms, a divalent cycloaliphatic hydrocarbon residue with 6 to 15 carbon atoms, a divalent aromatic hydrocarbon residue with 6 to 15 carbon atoms or a divalent araliphatic hydrocarbon residue with 7 to 15 carbon atoms, are suitable.

Examples of these diisocyanates are tetramethylene diisocyanate, methylpentamethylene diisocyanate, hexamethylene diisocyanate, dodecamethylene diisocyanate, 1,4-diisocyanatocyclohexane, 1-isocyanato-3,3,5-trimethyl-5-isocyanatomethyl cyclohexane, 4,4′-diisocyanatodicyclohexylmethane, 4,4′-diisocyanatodicyclohexylpropane-(2,2), 1,4-diisocyanatobenzene, 2,4-diisocyanato-toluene, 2,6-diisocyanatotoluene, 4,4′-diisocyanatodiphenylmethane, 2,2′- and 2,4′-diisocyanatodiphenylmethane, p-xylylene diisocyanate, p-isopropylidene diisocyanate, and mixtures consisting of these compounds.

The use of monomeric triisocyanates, such as 4-isocyanatomethyl-1,8-octane diisocyanate (nonane triisocyanate), is also possible.

It is also possible to incorporate minor quantities of monoisocyanates, such as e.g. stearyl isocyanate, butyl isocyanate, cyclohexyl isocyanate or benzyl isocyanate.

In addition to the above-mentioned monomeric isocyanates, the higher-molecular-weight derivative products of these monomeric isocyanates with uretdione, isocyanurate, urethane, allophanate, biuret, carbodiimide, iminooxadiazinedione and/or oxadiazinetrione structure which are known per se, as obtainable by a method that is known per se by modifying simple aliphatic, cycloaliphatic, araliphatic and/or aromatic diisocyanates, are also suitable.

The polyisocyanates used in c) are preferably based on hexamethylene diisocyanate, isophorone diisocyanate, 4,4′-diisocyanatodicyclohexylmethane, 1-methyl-2,4-diisocyanatocyclohexane, 1-methyl-2,6-diisocyanatocyclohexane, 2,4-diisocyanato-toluene and/or 2,6-diisocyanatotoluene.

Particularly preferably, a polyisocyanate component is used in c), which consists of 62 to 100 wt. % hexamethylene diisocyanate and/or polyisocyanates based on hexamethylene diisocyanate with uretdione, isocyanurate, urethane, allophanate, biuret, carbodiimide, iminooxadiazinedione and/or oxadiazinetrione structures, and of 0 to 38 wt. % isophorone diisocyanate, 4,4′-diisocyanatodicyclohexylmethane, 1-methyl-2,4-diisocyanatocyclohexane, 1-methyl-2,6-diisocyanatocyclohexane, 2,4-diisocyanatotoluene and/or 2,6-diisocyanatotoluene.

Most particularly preferably a polyisocyanate component is used in c) which consists of 100 wt. % hexamethylene diisocyanate and/or polyisocyanates based on hexamethylene diisocyanate with uretdione, isocyanurate, urethane, allophanate, biuret, carbodiimide, iminooxadiazinedione and/or oxadiazinetrione structures.

Component c) is generally used in quantities of 15 to 60 wt. %, preferably in quantities of 30 to 50 wt. %.

The component d) can also be selected e.g. from the group consisting of triazole, dimethyltriazole, dimethylpyrazole, tert.-butylbenzylamine, diisopropyl-amine, butanone oxime, epsilon-caprolactam, malonic acid diethyl ester, malonic acid dimethyl ester, acetoacetic ester, cyclopentanonecarboxyethyl ester, tert.-butylisopropylamine, dicyclohexylamine, ethylisopropylamine, cyclohexanone oxime, acetone oxime, phenol, dibutylamine, cyclohexanol, isopropanol and tert.-butanol.

The components d) can be split off again from the polyurethane dispersions according to the invention at elevated temperatures and thus produce free isocyanate groups which can enter into crosslinking reactions with suitable reactants. This makes it possible to formulate stable lacquers, coatings and adhesives at ambient temperature, which crosslink during or after application by means of temperature increase and cure to form high-quality products.

Suitable curing temperatures are generally 60 to 240° C., preferably 90 to 180° C. By adding suitable catalysts it may be possible to accelerate curing or to reduce the curing temperature.

It is also possible to use mixtures of different blocking agents as component d), in particular mixtures of blocking agents which unblock at different temperatures and thus enable a stepwise reaction to take place.

Preferred mixtures are mixtures of dimethylpyrazole and triazole, dimethylpyrazole and butanone oxime, dimethylpyrazole and diisopropylamine, and butanone oxime and epsilon-caprolactam.

Particularly preferably, component d) is selected from the group consisting of butanone oxime, triazole, diisopropylamine, malonic acid ester, acetoacetic ester, tert.-butylbenzylamine and dimethylpyrazole.

Component d) is preferably used in quantities of 2 to 30 wt. %, particularly preferably 4 to 18 wt. %.

Other components e) can be, for example:

e1) acid anhydrides, such as trimellitic anhydride, pyromellitic anhydride, phthalic anhydride, tetrahydrophthalic anhydride, hexahydrophthalic anhydride, maleic anhydride,
e2) components having a nonionically hydrophilising action, such as e.g. poly-oxyalkylene ethers which contain at least one hydroxy or amino group. These polyethers contain a proportion of 30 wt. % to 100 wt. % of building blocks that are derived from ethylene oxide. Polyethers with a linear structure having a functionality between 1 and 3 are suitable, but also compounds of general formula (I),

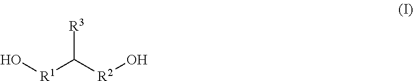

in which
R¹ and R² independently of one another each signify a divalent aliphatic, cycloaliphatic or aromatic residue with 1 to 18 C atoms, which can be interrupted by oxygen and/or nitrogen atoms, and
R³ denotes an alkoxy-terminated polyethylene oxide residue.

Compounds having a nonionically hydrophilising action also include e.g. monohydric polyalkylene oxide polyether alcohols having a statistical average of 5 to 70 ethylene oxide units per molecule, as are obtainable by a method which is known per se by alkoxylation of suitable starter molecules (e.g. in Ullmanns Encyclopadie der technischen Chemie, 4th edition, volume 19, Verlag Chemie, Weinheim pp. 31-38). Suitable starter molecules are e.g. saturated monoalcohols, such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols or hydroxymethylcyclohexane, 3-ethyl-3-hydroxymethyl oxetane or tetrahydrofurfuryl alcohol, diethylene glycol monoalkyl ethers, such as e.g. diethylene glycol monobutyl ether, unsaturated alcohols, such as allyl alcohol, 1,1-dimethylallyl alcohol or oleic alcohol, aromatic alcohols, such as phenol, the isomeric cresols or methoxy phenols, araliphatic alcohols, such as benzyl alcohol, anisyl alcohol or cinnamyl alcohol, secondary monoamines, such as dimethylamine, diethylamine, dipropylamine, diisopropylamine, dibutylamine, bis(2-ethylhexyl)amine, N-methyl- and N-ethylcyclohexylamine or dicyclohexylamine and heterocyclic secondary amines, such as morpholine, pyrrolidine, piperidine or 1H-pyrazole. Preferred starter molecules are saturated monoalcohols. Diethylene glycol monomethyl, monoethyl or monobutyl ether is particularly preferably used as starter molecule.

Suitable alkylene oxides for the alkoxylation reaction are in particular ethylene oxide and propylene oxide, which can be used in the alkoxylation reaction in any order or in a mixture.

The polyalkylene oxide polyether alcohols are either pure polyethylene oxide polyethers or mixed polyalkylene oxide polyethers, the alkylene oxide units of which consist of at least 30 mole %, preferably at least 50 mole % ethylene oxide units,

e3) monools, diols, triols, tetraols, such as e.g. benzyl alcohol, stearyl alcohol, 2-ethylhexyl alcohol, oleyl alcohol, butyl glycol, butyl diglycol, butanediol, hexanediol, neopentyl glycol, diethylene glycol, triethylene glycol, propylene glycol, dipropylene glycol, tetraethylene glycol and/or trimethylolpropane, trimethylolpropane, glycerol, pentaerythritol, dipentaerythritol, ethoxylated and/or propoxylated diols and/or triols e.g. based on diethylene glycol or trimethylolpropane,
e4) diamines, triamines, amino alcohols, such as e.g. ethylenediamine, 1,3-propylenediamine, 1,6-hexamethylenediamine, 1,4-butanediamine, hydrazine (hydrate), amino-functional polyethylene oxides or polypropylene oxides, which are available e.g. with the name Jeffamin® (Huntsman Corp. Europe, Belgium), alkoxysilane-group-containing mono- or diamines, diethylenetriamine, monoamines, such as e.g. butylamine or diethylamine, triethylenetetramine, isophorone diamine, diethanolamine, hydroxyethyl ethylenediamine, diisopropanolamine, N-methyl-ethanolamine, N-ethylethanolamine, N-methylisopropanolamine, bishydroxyethyl-ethylenediamine and/or triethanolamine,
e5) polyols with at least two hydroxyl groups and molecular weights of 400 to 20 000 g/mol, such as e.g. C2, C3 and/or C4 polyethers, polycarbonates, polymers, castor oil, alkyd resins with saturated or unsaturated fatty acids, unsaturated polyester resins, hydroxy-functional oligomers or polymers containing unsaturated groups, such as e.g. epoxy (meth)acrylates, ester (meth)acrylates, polyester (meth)acrylates, ether (meth)acrylates, polyether (meth)acrylates, urethane (meth)acrylates,
e6) epoxy-functional compounds, such as e.g. bisphenol A bisepoxide, glycidyl ester of versatic acid, glycidyl methacrylate, epoxy resins and
e7) unsaturated compounds, such as e.g. hydroxyethyl (meth)acrylate, hydroxypropyl (meth)acrylate, hydroxybutyl (meth)acrylate, ethoxylated and/or propoxylated hydroxyethyl (meth)acrylate, ethoxylated and/or propoxylated hydroxypropyl (meth)acrylate, ethoxylated and/or propoxylated hydroxybutyl (meth)acrylate, trimethylolpropane bisacrylate, glycerol bisacrylate, pentaerythritol trisacrylate, reaction products of glycidyl methacrylate and acids, such as e.g. acrylic acid, methacrylic acid, C4-C18 monocarboxylic acids, benzoic acid.

If diamines, triamines and/or amino alcohols are used as component e), these components can act as chain extenders for the previously produced isocyanate-functional and blocked isocyanate group-containing polyurethanes obtained from components a) to d) and optionally additional components e), and thus increase the molecular weight of the crosslinkable polyurethane dispersions. This chain extension reaction can take place both in the organic phase before the dispersing step and after the dispersing step in the aqueous phase.

Particularly preferred crosslinkable polyurethane dispersions according to the invention contain reaction products of

a) 30 to 65 wt. % of a hydroxy-functional aromatic polyester with an average OH functionality of 1.9 to 2.75, a molecular weight Mw of 900 to 3000 g/mol and an acid value of 0.5 to 5 mg KOH/g, which is the reaction product of
a1) 38 to 72 wt. % terephthalic acid and optionally isophthalic acid and/or phthalic anhydride, wherein a1) consists of at least 40 wt. % terephthalic acid,
a2) 20 to 55 wt. % of at least one compound selected from the group consisting of neopentyl glycol, ethylene glycol, propylene glycol, butanediol, diethylene glycol and hexanediol and
a3) 0 to 10 wt. % of at least one compound selected from the group consisting of adipic acid, castor oil, glycerol and trimethylolpropane,
b) 1 to 6 wt. % hydroxypivalic acid,
c) 30 to 50 wt. % of at least one, at least bifunctional polyisocyanate containing hexamethylene diisocyanate,
d) 4 to 18 wt. % of at least one compound selected from the group consisting of dimethylpyrazole, butanone oxime and caprolactam,
e) 0 to 20 wt. % of at least one compound selected from the group consisting of trimellitic anhydride, monohydroxy-functional hydrophilic polyethers, hydroxy-functional polyesters, hydroxy-functional C2, C3, C4 polyethers, hydroxy-functional polycarbonates, ethylenediamine, isophorone diamine, diethanolamine, N-methyl-ethanolamine, hydroxyethylethylenediamine, hydrazine, hydrazine hydrate, diethylenetriamine, stearyl alcohol and benzyl alcohol,
the percentages a) to e) and a1) to a3) adding up to 100% in each case.

Particularly preferred crosslinkable polyurethane dispersions according to the invention contain reaction products of

a) 30 to 65 wt. % of a hydroxy-functional aromatic polyester with an average functionality of 1.9 to 2.75, a molecular weight Mw of 900 to 3000 g/mol and an acid value of 0.5 to 5 mg KOH/g substance, which is the reaction product of
a1) 38 to 72 wt. % terephthalic acid and optionally isophthalic acid and/or phthalic anhydride, wherein a1) consists of at least 40 wt. % terephthalic acid,
a2) 20 to 55 wt. % of at least one compound selected from the group consisting of neopentyl glycol, ethylene glycol, propylene glycol, butanediol, diethylene glycol and hexanediol and
a3) 0 to 10 wt. % of at least one compound selected from the group consisting of adipic acid, castor oil, glycerol and trimethylolpropane,
b) 1 to 6 wt. % dimethylolpropionic acid,
c) 30 to 50 wt. % of at least one, at least bifunctional polyisocyanate containing hexamethylene diisocyanate,
d) 4 to 18 wt. % butanone oxime and/or caprolactam,
e) 0 to 20 wt. % of at least one compound selected from the group consisting of trimellitic anhydride, monohydroxy-functional hydrophilic polyethers, hydroxy-functional polyesters, hydroxy-functional C2, C3, C4 polyethers, hydroxy-functional polycarbonates, ethylenediamine, isophorone diamine, diethanolamine, N-methylethanolamine, hydroxyethylethylenediamine, hydrazine, hydrazine hydrate, diethylenetriamine, stearyl alcohol and benzyl alcohol,
the percentages a) to e) and a1) to a3) adding up to 100% in each case.

Various processes can be used for the production of the crosslinkable polyurethane dispersions according to the invention.

In a one-stage production process, the components a), b), d) and optionally e) are initially added to a solvent. At 20 to 100, preferably 40 to 70° C., component c) is then added and the mixture is stirred with the optional addition of a catalyst until the desired isocyanate content is reached. Next, optionally neutralising agents (again) and optionally additional organic solvents and/or auxiliary substances are added and the mixture is dispersed or dissolved by adding water or by transferring to a prepared aqueous phase, optionally neutralising agents and/or auxiliary substances are then added (again) and finally excess quantities of solvent are optionally completely or partially separated off by distillation.

The isocyanate content after the reaction of the components is <2.5%, preferably <1.0% and particularly preferably <0.1%.

The reaction of components a), b), c) d) and optionally e) can be performed with or without the addition of catalytically active substances. Suitable catalysts are the metal catalysts common in polyurethane chemistry, such as e.g. tin compounds such as dibutyltin dilaurate, Formrez® UL 29 (tin catalyst; Witco, USA), butyltin oxide, dibutyltin oxide, Fascat® 4100 (tin catalyst, Arkema, France), tin chloride, tin(II) octoate or bismuth octoate, phenyl mercury acetate; also suitable are amine catalysts, such as e.g. triethylamine, dimethylcyclohexylamine, diazabicyclononene, diazabicyclooctane, diazabicycloundecene and/or dimethylaminopyridine. The reaction preferably takes place in the presence of catalysts. Particularly preferred is the use of 25 to 250 ppm catalysts, based on the quantities of components a), b), c), d) and optionally e).

Suitable solvents are, in principle, all non-isocyanate-reactive solvents, preferably acetone, methyl ethyl ketone, methyl isobutyl ketone, solvent naphtha, toluene, xylene, cyclohexane, methoxypropyl acetate, N-methylpyrrolidone, N-ethyl-pyrrolidone, diethylene glycol dimethyl ether, dipropylene glycol dimethyl ether, ethylene glycol dimethyl ether or tetramethoxymethane. After the reaction of the components, hydroxy-functional solvents, such as e.g. butyl glycol, butyl diglycol, methoxypropanol, ethoxypropanol, ethylene glycol and/or propylene glycol, can also be added.

Particularly preferred is the use of acetone, optionally also in combination with other solvents.

Most particularly preferred is the exclusive use of acetone, in quantities of 5 to 65, preferably of 10 to 35 wt. %.

The pH values of the polyurethane dispersions according to the invention are between 6 and 11, preferably between 6.5 and 9.5.

The polyurethane dispersions according to the invention can also be produced in a two-stage production process, wherein an isocyanate-functional intermediate product is first produced by reaction of components a), b), c) and optionally e), optionally in solvent and optionally in the presence of suitable catalysts, and this is then reacted with the blocking agent d), additional solvents and/or neutralising agents then optionally being added, and dispersion is carried out by adding water to the polymer solution or by adding the polymer solution to water and optionally neutralising agents and/or auxiliary substances are then added (again) and finally excess quantities of solvent are optionally completely or partially separated off by distillation.

The polyurethane dispersions according to the invention can also be produced in a three-stage production process, wherein an isocyanate-functional intermediate product is first produced by reaction of components a), b), c) and optionally e), optionally in solvent and optionally in the presence of suitable catalysts, and this is then reacted with the blocking agent d) in such a way that a certain quantity of isocyanate groups is still available for further reactions, additional solvents and/or neutralising agents are then optionally added, and dispersion is carried out by adding water to the polymer solution or by adding the polymer solution to water and optionally neutralising agents and/or auxiliary substances are then added (again), a chain extension reaction with at least one amino-functional component e) being performed before or after the dispersing step, and finally excess quantities of solvent are optionally completely or partially separated off by distillation.

The polyurethane dispersions according to the invention can also be produced in a multi-stage production process, wherein an isocyanate-functional intermediate product is initially produced in a first reaction step by reaction of components a), c) and optionally d) and optionally e), optionally in solvent and optionally in the presence of suitable catalysts, and this is then reacted in a second reaction step with component b) and optionally in a further reaction step, if this has not already taken place in the first reaction step, is reacted with the blocking agent d), additional solvents and/or neutralising agents then optionally being added, and dispersion is carried out by adding water to the polymer solution or by adding the polymer solution to water and optionally neutralising agents and/or auxiliary substances are then added (again), and finally excess quantities of solvent are optionally completely or partially separated off by distillation.

It is also possible to produce the crosslinkable polyurethane dispersions according to the invention in such a way that, in addition to the blocked isocyanate groups, they also have free hydroxyl groups. This can be achieved e.g. by reacting components a), b) c) and d) together in such a way that free isocyanate groups are still available for further reactions and are then reacted in a further reaction step with an excess of hydroxy-functional and/or amino- and hydroxy-functional components e). As already described above, neutralisation, dispersion and optional removal of the solvent by distillation then take place.

This then results in crosslinkable polyurethane dispersions according to the invention which, in addition to blocked isocyanate groups, also have free hydroxyl groups and thus, after application and after unblocking of the blocked isocyanate groups at elevated temperature, can crosslink with themselves without any additional components necessarily being required.

The crosslinkable polyurethane dispersions according to the invention, which, in addition to the blocked isocyanate groups, additionally contain free hydroxyl groups, are preferably obtained by reacting components a), b) c) and d) together in such a way that free isocyanate groups are still available for further reactions, and these are then reacted in a further reaction step with at least one amino- and hydroxy-functional component e) in such a way that, for each free isocyanate group, 0.9 to 1.1 molecules of components e) with one amino group and one or two hydroxy groups are used. As already described above, neutralisation, dispersion and optional removal of the solvent by distillation then take place.

The reactive polyurethane dispersions according to the invention contain preferably a maximum of 8, particularly preferably a maximum of 3 wt. % and most preferably less than 1 wt. % organic solvents. The optional removal of excess quantities of solvent by distillation can take place e.g. under reduced pressure at e.g. 20 to 80° C. during or after dispersion in/with distilled water.

The solids content of the polyurethane dispersions according to the invention is 30 to 65 wt. %, preferably 35 to 55 wt. %.

The polyurethane dispersions according to the invention have particle diameters, determined e.g. by LCS measurements, of preferably 25 to 500, particularly preferably 25 to 160 nm.

The crosslinkable polyurethane dispersions according to the invention can be used individually, but preferably mixed in combination with other ionically or nonionically hydrophilised aqueous dispersions, solutions, emulsions and/or suspensions or water-dilutable, water-dispersible and/or water-soluble polymers, oligomers and/or monomers and used together. These binder combinations are stable when stored at ambient temperature and can be reacted at elevated temperature to produce crosslinked polymers.

The present invention thus also provides aqueous combinations of binders having a long shelf life, containing

A) at least one aqueous dispersion, solution, emulsion and/or suspension of a polymer or oligomer, or at least one water-dilutable, water-dispersible and/or water-soluble polymer and/or oligomer and/or monomer and
B) at least one crosslinkable polyurethane dispersion according to the invention.

The invention also provides aqueous combinations of binders having a long shelf life, containing

A) 40 to 98 wt. % of at least one aqueous dispersion, solution, emulsion and/or suspension of a hydroxy-functional polymer or oligomer, or of at least one aqueous or water-dilutable or water-dispersible hydroxy-functional polymer and/or oligomer and/or monomer,
B) 2 to 60 wt. % of at least one crosslinkable polyurethane dispersion according to the invention.

The following polymers, oligomers or monomers, for example, are suitable in principle as component A): polyvinyl acetates, polyethylenes, polystyrenes, polybutadienes, polyvinyl chlorides, polyethers, polyurethanes, polyurethane-polyureas, polyureas, polyesters, alkyds, unsaturated polyesters, epoxides, polyepoxides, polyacrylates and/or copolymers in 100%, in dissolved or in dispersed form, particularly in the form of aqueous dispersions, solutions, emulsions and/or suspensions.

Such mixtures should always be checked for compatibility, the dispersions according to the invention being distinguished by very good compatibility with a wide variety of aqueous dispersions, solutions, emulsions and/or suspensions.

Preferably, hydroxy-functional polymers or oligomers are used in the form of aqueous dispersions, emulsions and/or solutions or in water-dilutable or water-dispersible form as component A).

Preferred polymers A) are hydroxy-functional polyesters, polyurethanes, polyethers, polyester-polyurethanes, polyether-polyurethanes, polycarbonates, polyurethane-polycarbonates, polyurethane-polyureas, alkyd resins and/or polyacrylates in aqueous solution, dispersion and/or emulsion.

The polymers A) preferably have hydroxyl group contents (based on solids content) of 0.3 to 8, particularly preferably 0.75 to 4 wt. %.

It is also possible to use amino-functional polymers, oligomers or monomers as component A). These binder combinations can then also be cured at lower temperatures, e.g. at 40 to 80° C. Polymers crosslinked via urea groups then result. The processing time of these binder combinations is naturally limited in this case, and shorter than with the use of hydroxy-functional components A).

The invention therefore also provides binder combinations containing

A) 3 to 70 wt. % of at least one aqueous dispersion, solution, emulsion and/or suspension of an amino-functional polymer or oligomer, or of at least one aqueous or water-dilutable or water-dispersible amino-functional polymer and/or oligomer and/or monomer,
B) 30 to 97 wt. % of at least one crosslinkable polyurethane dispersion according to the invention.

It is also possible to use binder combinations based on the crosslinkable polyurethane dispersions B) according to the invention which, in addition to at least one component A), contain one or more additional components C).

Suitable components C) can be: crosslinking agents, such as carbodiimides, polyisocyanates with free isocyanate groups, blocked polyisocyanates, amino crosslinker resins, such as e.g. partially or completely etherified melamine resins or urea-formaldehyde condensation products or crosslinking aminoplastic resins as described e.g. in “Methoden der organischen Chemie” Houben-Weyl, vol. 14/2, part 2, 4^{th} edition, Georg Thieme Verlag Stuttgart, 1963, pp. 319 ff.

Suitable blocked polyisocyanates C) are e.g. reaction products of bifunctional isocyanates such as e.g. isophorone diisocyanate, hexamethylene diisocyanate, 2,4- or 2,6-diisocyanatotoluene, 4,4′-diphenylmethane diisocyanate and/or higher molecular-weight trimers thereof, biurets, urethanes and/or allophanates with blocking agents such as e.g. methanol, ethanol, butanol, hexanol, benzyl alcohol, acetoxime, butanone oxime, caprolactam, phenol, diethyl malonate, dieethyl malonate, dimethylpyrazole, triazole, dimethyltriazole, acetoacetic ester, diisopropylamine, dibutylamine, tert.-butylbenzylamine, cyclopentanone-carboxyethyl ester, dicyclohexylamine and/or tert.-butylisopropylamine

The above-mentioned blocked polyisocyanates can also be converted to a water-dispersible form by incorporating hydrophilic groups, such as e.g. carboxylate, sulfonate and/or polyethylene oxide structures, and thus used in combination with the dispersions according to the invention.

Preferred components C) are amino crosslinker resins, such as e.g. partially or completely etherified melamine resins or urea-formaldehyde condensation products or crosslinking aminoplastic resins as described e.g. in “Methoden der organischen Chemie” Houben-Weyl, vol. 14/2, part 2, 4th edition, Georg Thieme Verlag Stuttgart, 1963, pp. 319 ff.

The invention therefore also provides combinations of binders containing

A) 20 to 98 wt. % of at least one aqueous dispersion, solution, emulsion and/or suspension of a hydroxy-functional polymer or oligomer, or of at least one aqueous or water-dilutable or water-dispersible hydroxy-functional polymer and/or oligomer and/or monomer,
B) 2 to 50 wt. % of at least one crosslinkable polyurethane dispersion according to the invention,
C) 0.5 to 25 wt. % of at least one amino crosslinker resin and/or blocked polyisocyanate.

For the use according to the invention of the polyurethane dispersions according to the invention, the conventional auxiliary substances and additives can be added to them. These include e.g. organic and/or inorganic pigments or metallic pigments based on aluminium flakes; fillers, such as e.g. carbon black, silica, talcum, kaolin, glass as powder or in the form of fibres, cellulose and mixtures thereof and/or other materials common in the production of lacquers, coatings and adhesives.

The binder combinations produced on the basis of the crosslinkable polyurethane dispersions according to the invention are preferably used for stoving lacquers and coatings which are cured at temperatures of 90 to 240, preferably of 90° to 180° C.

Possible areas of application are the coating, treatment, lacquering of glass, glass fibres, all kinds of metallic substrates, ceramic materials, all kinds of plastics, stone, concrete, porcelain, textiles, leather, bitumen, hardboard, wood, timber-based materials and composites or composite materials.

Preferred areas of application are e.g. stoving filler coatings, one-coat lacquers, stone impact protection primers, base coats, clear lacquers, pigmented top coats, decorative coatings, anti-corrosive coatings and glass fibre sizes.

Preferably high-quality lacquers and coatings with high film hardness together with high elasticity, good film appearance and solvent and chemical resistance and very good adhesion to various substrates are obtained therewith, which additionally enable films to be obtained after drying at room temperature which are tack-free and thus not sensitive to dust, for example.

The production of the binder combinations according to the invention generally takes place by mixing the finished polyurethane dispersion according to the invention with one or more of the described components A) and optionally C).

To achieve special effects it is also possible to add small quantities of auxiliary substances which are conventional in the coatings and adhesives industry during production of the polyurethane dispersions according to the invention, such as e.g. surface-active substances, emulsifiers, stabilisers, anti-settling agents, UV-stabilisers, catalysts for the crosslinking reaction, defoamers, antioxidants, anti-skinning agents, flow control agents, thickeners and/or bactericides.

### EXAMPLES

### Aromatic Terephthalic Acid Polyester A)

4784 g terephthalic acid, 4784 g isophthalic acid, 3460 g neopentyl glycol, 2274 g ethylene glycol and 267 g castor oil are weighed into an esterification vessel and heated to 140° C. under a flow of nitrogen. The mixture is then heated in steps (10° C./hour) to the reaction temperature of 210° C., with stirring, and esterified for 4 hours at this temperature, and is then heated to 230° C. and esterified under a nitrogen atmosphere until an acid value of 3 mg KOH/g substance is reached. The polyester is then cooled and decanted. The 100% aromatic terephthalic acid polyester A) has a hydroxyl equivalent weight of 623 g/mol.

### Polyurethane Dispersion 1)

473.5 g polyester A) and 22.4 g hydroxypivalic acid are dissolved in 386 hot acetone and then 73 g dimethylpyrazole are added. Next, while stirring at 45° C., 333.5 g Desmodur® N 3300 (aliphatic polyisocyanate with isocyanurate structural units based on hexamethylene diisocyanate; isocyanate equivalent weight 195 g/mol, Bayer Material Science AG, Leverkusen, Germany) are added and the batch is admixed with 150 ppm Desmorapid® SO (tin catalyst Bayer Material Science AG, Leverkusen, Germany) and stirred at 50° C. until the isocyanate content is <0.1%. After adding 16.9 g dimethylethanolamine, dispersion is carried out by adding 1350 g distilled water and the acetone is distilled off in a slight vacuum. A crosslinkable, solvent-free polyurethane dispersion 1) containing blocked isocyanate groups is obtained with a solids content of 40%, a pH value of 8.1, a viscosity of 22 mPAs/23° C. and an average particle size of 70 nm.

### Polyurethane Dispersion 2)

320.3 g polyester A), 14.9 g hydroxypivalic acid and 41.7 g dimethylpyrazole are dissolved in 304 g hot acetone with stirring. Next, while stirring, 150 ppm Desmorapid® SO are added and then, at 45° C., a mixture of 163.8 g Desmodur® N 3300 and 23.5 g hexamethylene diisocyanate, and the batch is stirred at 55° C. until the isocyanate content is 0.1%. After adding 11.2 g dimethylethanolamine, dispersion is carried out by adding 700 g distilled water and the acetone is distilled off in a slight vacuum. A crosslinkable polyurethane dispersion 2) containing blocked isocyanate groups is obtained with a solids content of 47%, a pH value of 8.1, a viscosity of 34 mPAs/23° C. and an average particle size of 99 nm.

### Polyurethane Dispersion 3)

377.5 g polyester A), 24.7 g hydroxypivalic acid and 91.3 g dimethylpyrazole are dissolved in 193 g hot acetone with stirring. Next, while stirring, 250 ppm Desmorapid® SO are added and then, at 45° C., a mixture of 214.5 g Desmodur® N 3300 and 62.8 g hexamethylene diisocyanate, and the batch is stirred at 50° C. until the isocyanate content is <0.1%. After adding 18.6 g dimethylethanolamine, dispersion is carried out by adding 790 g distilled water and the acetone is distilled off in a slight vacuum. A crosslinkable polyurethane dispersion 3) containing blocked isocyanate groups is obtained with a solids content of 49%, a pH value of 8.1, a viscosity of 74 mPAs/23° C. and an average particle size of 71 nm.

### Polyurethane Dispersion 4)

263.1 g polyester A), 27.8 g hydroxypivalic acid and 115.9 g dimethylpyrazole are dissolved in 242 g hot acetone with stirring. Next, while stirring, 150 ppm Desmorapid® SO are added and then, at 45° C., a mixture of 273.6 g Desmodur® N 3300 and 44.4 g hexamethylene diisocyanate, and the batch is stirred at 50° C. until the isocyanate content is <0.1%. After adding 21 g dimethylethanolamine, dispersion is carried out by adding 700 g distilled water and the acetone is distilled off in a slight vacuum. A crosslinkable polyurethane dispersion 4) containing blocked isocyanate groups is obtained with a solids content of 52%, a pH value of 8.1, a viscosity of 115 mPAs/23° C. and an average particle size of 69 nm.

### Polyurethane Dispersion 5)

366.1 g polyester A), 18.9 g hydroxypivalic acid, 21.5 g trimethylolpropane and 30.7 g dimethylpyrazole are dissolved in 251 g hot acetone with stirring. Next, while stirring, 250 ppm Desmorapid® SO are added and then, at 45° C., 147.8 g hexamethylene diisocyanate, and the batch is stirred at 58° C. until the isocyanate content is 0.8%. Next, 3.7 g ethylenediamine dissolved in 10 g water are added and the batch is stirred for 15 minutes. Neutralisation is then carried out with 14.2 g dimethylethanolamine, dispersion is carried out by adding 1050 g distilled water and the acetone is distilled off in a slight vacuum. A chain-extended, crosslinkable polyurethane dispersion 5) containing blocked isocyanate groups is obtained with a solids content of 40%, a pH value of 7.9, a viscosity of 44 mPAs/23° C. and an average particle size of 87 nm.

### Polyurethane Dispersion 6)

450.5 g polyester A), 31 g hydroxypivalic acid, 28.2 g trimethylolpropane and 60.5 g dimethylpyrazole are dissolved in 328 g hot acetone with stirring. Next, while stirring, 150 ppm Desmorapid® SO are added and then, at 45° C., 194 g hexamethylene diisocyanate, and the batch is stirred at 50° C. until the isocyanate content is <0.1%. Neutralisation is then carried out with 23.4 g dimethylethanolamine, dispersion is carried out by adding 1350 g distilled water and the acetone is distilled off in a slight vacuum. A crosslinkable polyurethane dispersion 6) containing blocked isocyanate groups is obtained with a solids content of 46%, a pH value of 7.9, a viscosity of 78 mPAs/23° C. and an average particle size of 45 nm.

### Polyurethane Dispersion 7)

355 g polyester A), 11.8 g hydroxypivalic acid and 84.5 g dimethylpyrazole are dissolved in 200 g hot acetone with stirring. Next, while stirring, 250 ppm Desmorapid® SO are added and then, at 45° C., a mixture of 42 g hexamethylene diisocyanate, 22.2 g isophorone diisocyanate and 191.1 g Desmodur N® 3300, and the batch is stirred at 50° C. until the isocyanate content is 0.4%. 11.5 g trimellitic anhydride are then added and the batch is stirred at 50° C. until no more anhydride bands can be detected in the IR spectrum. Neutralisation is then carried out with 17.6 g dimethylethanolamine, dispersion is carried out by adding 880 g distilled water and the acetone is distilled off in a slight vacuum. A doubly hydrophilised, crosslinkable polyurethane dispersion 7) containing blocked isocyanate groups is obtained with a solids content of 47%, a pH value of 7.9, a viscosity of 80 mPAs/23° C. and an average particle size of 91 nm.

### Polyurethane Dispersion 8)

305 g polyester A), 36.2 g dimethylolpropionic acid and 65.8 g dimethylpyrazole are dissolved in 200 g hot acetone with stirring. Next, while stirring, 0.1 g Desmorapid® SO are added and then, at 45° C., a mixture of 132.3 g hexamethylene diisocyanate and 58.3 g isophorone diisocyanate, and the batch is stirred at 50° C. until the isocyanate content is 1.9%. 15.3 g diethylenetriamine diluted with 15 g acetone are then added and the batch is stirred at 50° C. until the isocyanate content is <0.1%. Neutralisation is then carried out with 24 g dimethylethanolamine, dispersion is carried out by adding 890 g distilled water and the acetone is distilled off in a slight vacuum. A chain-extended, crosslinkable polyurethane dispersion 8) containing blocked isocyanate groups is obtained with a solids content of 41%, a pH value of 9.1, a viscosity of 600 mPAs/23° C. and an average particle size of 130 nm.

### Polyurethane Dispersion 9)

268.4 g polyester A), 25.1 g dimethylolpropionic acid, 4.1 g stearyl alcohol and 56.2 g dimethylpyrazole are dissolved in 220 g hot acetone with stirring. Next, while stirring, 0.1 g Desmorapid® SO are added and then, at 45° C., a mixture of 63 g hexamethylene diisocyanate, 16.7 g isophorone diisocyanate and 87.8 Desmodur® N3300, and the batch is stirred at 50° C. until the isocyanate content is <0.1%. Neutralisation is then carried out with 16.7 g dimethylethanolamine, dispersion is carried out by adding 780 g distilled water and the acetone is distilled off in a slight vacuum. A crosslinkable polyurethane dispersion 9) containing blocked isocyanate groups is obtained with a solids content of 38%, a pH value of 8, a viscosity of 500 mPAs/23° C. and an average particle size of 64 nm.

### Comparative Dispersion 10)

For comparison purposes, Example 5 of EP 1862486 was reproduced. This polyurethane dispersion contains a reaction product of Desmodur® N3300, dimethylpyrazole, trimethylolpropane and hydroxypivalic acid.

The crosslinkable polyurethane dispersions 8) and 9) according to the invention were tested in comparison with comparative dispersion 10) in combination with a hydroxy-functional polyester-polyurethane dispersion as a stoving lacquer. The quantitative ratios were selected such that the ratio of blocked isocyanate groups to hydroxyl groups was 1:1.

| | | |
|---|---|---|
| Example 9 | Example 8 | Comparison 10 |

Binder ratio NCO:OH = 1.0

| Polyurethane dispersion 9) | | 123.5 | | |
|---|---|---|---|---|
| Polyurethane dispersion 8) | | | 116.2 | |
| Comparative Example 11) | | | | 68.6 |
| OH dispersion | | 80.0 | 80.0 | 100.0 |
| Bayhydrol PT 241 ¹⁾ | | | | |
| Additol XW 395, as | | 1.4 | 1.4 | 1.2 |
| supplied | | | | |
| Surfynol 104E, as | | 1.4 | 1.4 | 1.2 |
| supplied | | | | |
| DMEA, 10% in water | | | | 1.0 |
| Distilled water | | 12.3 | 13.0 | 13.0 |
| Total quantity in g | | 218.6 | 212.0 | 185.0 |
| Viscosity: efflux time | immediate [s] | 41 | 38 | 39 |
| DIN ISO 5 | after storing for 10 | 31 | 28 | 29 |
| | days at 40° C. [s] | | | |
| pH in lacquer | | 8.1 | 8.1 | 8.1 |
| Solids in lacquer | | 37% | 38% | 37% |

Stoving condition: 10′RT + 30′ 120° C.

| | | | | |
|---|---|---|---|---|
| Lacquer film | | OK | OK | OK |
| appearance | | | | |
| Pendulum hardness | [s] | 153 | 153 | 85 |
| according to DIN | | | | |
| 53157 | | | | |
| Solvent resistance 1′ ²⁾ | [0-5] | 2244 | 2244 | 2244 |
| Erichsen indentation | mm | 10.0 | 10.0 | 10.0 |
| according to DIN | | | | |
| 53157 | | | | |
| Impact test | in/out | >80/>80 | >80/>80 | >80/>80 |
| Cross-hatch adhesion test | | 0 | 0 | 2 |
| according to DIN 53151 ³⁾ | | | | |
| Salt-spray test | Creep corrosion | 25 | 32 | 45 |
| according to DIN | after 144 hours in | | | |
| 53167 | mm | | | |

Stoving condition: 10′RT + 30′ 140° C.

| | | | | |
|---|---|---|---|---|
| Paint film appearance | | OK | OK | OK |
| Pendulum hardness | [s] | 197 | 197 | 121 |
| according to DIN | | | | |
| 53157 | | | | |
| Solvent resistance 1′ ²⁾ | [0-5] | 0024 | 0024 | 2244 |
| Erichsen indentation | mm | 10.0 | 10.0 | 10.0 |
| according to DIN | | | | |
| 53157 | | | | |
| Impact test | in/out | >80/>80 | >80/>80 | >80/>80 |
| Cross-hatch adhesion | | 0 | 0 | 2 |
| test according to DIN | | | | |
| 53151 ³⁾ | | | | |
| Salt-spray test | Creep corrosion | 6 | 7 | 12 |
| according to DIN | after 144 hours in | | | |
| 53167 | mm | | | |

¹⁾ Bayhydrol PT 241: 40% hydroxy-functional polyester-polyurethane dispersion, (Bayer MaterialScience AG, Leverkusen Germany)
²⁾ The solvent resistance is determined by exposing the lacquer to 4 different solvents for 1 minute and then visually evaluating the damage occurring: 0 = no damage (best score); 5 = dissolved (worst score). The sequence of the solvents is: xylene/methoxypropyl acetate/ethyl acetate/acetone.
³⁾ 0 = optimum adhesion, no damage, 5 = poor adhesion, severe damage

All lacquers display good storage stability when stored at 40° C.

The films based on the polyurethane dispersions according to the invention are tack-free after application and solvent evaporation at room temperature, in contrast to the comparative test, and are thus substantially less sensitive e.g. to dust or foreign body inclusions or to unintentional contact.

The film appearance of all the lacquers was acceptable, and body, gloss and flow met the requirements in full.

When the lacquers are cured at 120° C., the lacquers according to the invention display significantly higher hardness compared with the comparative example, with comparable excellent elasticity and adequate solvent resistance.

The lacquers based on the dispersions according to the invention additionally display better adhesion in the cross-hatch test and a better result in the salt-spray test; creep corrosion by rust at a cut is lower.

When cured at 140° C., the lacquers based on the dispersions according to the invention display an excellent overall property profile. They combine in a previously unknown manner very high hardness with excellent elasticity, together with very good adhesion, a very good salt-spray test result and good solvent resistance.

The dispersions according to the invention enable stoving lacquers to be produced with a previously unknown level of properties and represent significant progress over the prior art.

### Polyurethane Dispersion 11)

377.5 g polyester A) and 24.7 g hydroxypivalic acid are dissolved in 170 g hot acetone with stirring and then 82.9 g butanone oxime are added. Next, while stirring, 250 ppm Desmorapid® SO are added and then, at 45° C., a mixture of 62.8 g hexamethylene diisocyanate and 214.5 g Desmodur® N3300, and the batch is stirred at 50° C. until the isocyanate content is <0.1%. Neutralisation is then carried out with 18.6 g dimethylethanolamine, dispersion is carried out by adding 780 g distilled water and the acetone is distilled off in a slight vacuum. A crosslinkable polyurethane dispersion 10) containing blocked isocyanate groups is obtained with a solids content of 50%, a pH value of 8.2, a viscosity of 20 mPAs/23° C. and an average particle size of 84 nm.

### Polyurethane Dispersion 12)

391.4 g polyester A) and 24.7 g hydroxypivalic acid are dissolved in 170 g hot acetone with stirring and then 107.6 g epsilon-caprolactam are added. Next, while stirring, 250 ppm Desmorapid® SO are added and then, at 45° C., a mixture of 62.8 g hexamethylene diisocyanate and 214.5 g Desmodur® N3300, and the batch is stirred at 50° C. until the isocyanate content is <0.1%. Neutralisation is then carried out with 18.6 g dimethylethanolamine, dispersion is carried out by adding 780 g distilled water and the acetone is distilled off in a slight vacuum. A crosslinkable polyurethane dispersion 12) containing blocked isocyanate groups is obtained with a solids content of 50%, a pH value of 8.2, a viscosity of 20 mPAs/23° C. and an average particle size of 84 nm.

### Polyurethane Dispersion 13)

356.2 g polyester A), 33.5 g Desmophen® 670 (Bayer Material Science AG, Leverkusen, Germany, hydroxy-functional, branched aromatic polyester with an OH equivalent weight of 372 g/mol), 50.3 g dimethylpyrazole and 6.9 g dimethylol-propionic acid are dissolved in 170 g hot acetone with stirring. Next, while stirring, 250 ppm Desmorapid® SO are added and then, at 45° C., a mixture of 90.7 g hexamethylene diisocyanate and 105.3 g Desmodur® N3300, and the batch is stirred at 50° C. until the isocyanate content is 1.4%. 27.5 g diethanolamine are then added all at once and the batch is stirred until the isocyanate content is <0.1%. Neutralisation is then carried out with 4.6 g dimethylethanolamine, dispersion is carried out by adding 11500 g distilled water and the acetone is distilled off in a slight vacuum. A self-crosslinking polyurethane dispersion 13) containing blocked isocyanate groups is obtained with a solids content of 39%, a pH value of 7.8, a viscosity of 220 mPAs/23° C. and an average particle size of 100 nm.

### Polyurethane Dispersion 14)

306.6 g polyester A), 28.6 g hydroxypivalic acid, 33.8 g glycerol and 94.5 g dimethylpyrazole are dissolved in 301 g hot acetone with stirring. Next, while stirring, 150 ppm Desmorapid® SO are added and then, at 45° C., 240 g hexamethylene diisocyanate, and the batch is stirred at 50° C. until the isocyanate content is <0.1%. Neutralisation is then carried out with 21.5 g dimethyl-ethanolamine, dispersion is carried out by adding 900 g distilled water and the acetone is distilled off in a slight vacuum. A crosslinkable polyurethane dispersion 14) containing blocked isocyanate groups is obtained with a solids content of 54%, a pH value of 7.1, a viscosity of 11 mPAs/23° C. and an average particle size of 100 nm.

### Polyurethane Dispersion 15)

263.1 g polyester A), 30.9 g 6-aminohexanoic acid and 115.9 g dimethylpyrazole are dissolved in 242 g hot acetone with stirring. Next, while stirring, 150 ppm Desmorapid® SO are added and then, at 45° C., a mixture of 273.6 g Desmodur® N 3300 and 44.4 g hexamethylene diisocyanate, and the batch is stirred at 50° C. until the isocyanate content is <0.1%. After adding 21 g dimethylethanolamine, dispersion is carried out by adding 700 g distilled water and the acetone is distilled off in a slight vacuum. A crosslinkable polyurethane dispersion 15) containing blocked isocyanate groups is obtained with a solids content of 49%, a pH value of 7.8, a viscosity of 14 mPas/23° C. and an average particle size of 87 nm.

The self-crosslinking polyurethane dispersion 13) was tested under two different stoving conditions:

### Example 13

Paint film appearance after drying at room temperature

| | | |
|---|---|---|
| Fisheyes | q (0-5) s (0-5)⁴⁾ | q1 s1 |

| | |
|---|---|
| Flow; body | very good |
| Surface | tack-free |
| Stoving condition: 10 min. RT + 30 min. 140° C. | |
| Pendulum hardness in (s) according to DIN 53157 | 216 |
| Erichsen indentation in (mm) according to DIN 53157 | 10 |
| Solvent resistance 1 min. (0-5) | 0224 |
| (sequence of solvents: xylene/ | |
| methoxypropyl acetate/ethyl | |
| acetate/acetone) | |
| Cross-hatch adhesion test according to DIN 53151 | 0 |
| Appearance of lacquer film | OK |
| Stoving condition: 10 min. RT + 30 min. 160° C. | |
| Pendulum hardness in (s) according to DIN 53157 | 217 |
| Erichsen indentation in (mm) according to DIN 53157 | 10 |
| Solvent resistance 1 min. (0-5) | 0024 |
| Cross-hatch adhesion test according to DIN 53151 | 0 |
| Appearance of lacquer film | OK |

⁴⁾Evaluation of quantity q and size s of fisheyes/gel particles in film. 0 = best value, 5 = worst value

The dispersion 13) according to the invention also gave excellent film values in terms of hardness, elasticity, adhesion, film appearance and drying.

The crosslinkable polyurethane dispersions 11) and 12) according to the invention were tested as described above in combination with a hydroxy-functional polyester-polyurethane dispersion as a stoving lacquer. The stoving temperature was 160° C. The quantitative ratios were selected such that the ratio of blocked isocyanate groups to hydroxyl groups was 1:1. The following test results were obtained:

| Example | Example |
|---|---|
| 11 | 12 |

Binder ratio NCO:OH = 1.0
Stoving condition: 10′RT + 30′ 160° C.

| | | | |
|---|---|---|---|
| Drying at room temperature | | tack-free | tack-free |
| Pendulum hardness according to | [s] | 164 | 171 |
| DIN 53157 | | | |
| Solvent resistance 1′ (sequence | [0-5] | 0011 | 0022 |
| of solvents: xylene/methoxypropyl | | | |
| acetate/ethyl acetate/acetone) | | | |
| Erichsen indentation according to | mm | 10.0 | 10.0 |
| DIN 53157 | | | |
| Impact test | in/out | >80/>80 | >80/>80 |
| Cross-hatch adhesion test | | 0 | 0 |
| according to DIN 53151 | | | |
| Salt-spray test according to DIN | Creep | 6 | 5 |
| 53167 | corrosion | | |
| | after 144 | | |
| | hours in mm | | |

Under these stoving conditions too, excellent values were obtained in terms of hardness, elasticity, solvent resistance, adhesion and salt-spray test.

1. A cross-linkable polyurethane dispersion comprising
a) at least one hydroxy-functional aromatic polyester with an average OH functionality of 1.5 to 3.5 produced from terephthalic acid,
b) at least one isocyanate-reactive hydrophilising agent having at least one acid group and at least one group which is reactive towards isocyanate groups,
c) at least one, at least bifunctional polyisocyanate and
d) at least one blocking agent which is reactive towards NCO groups.

2. A cross-linkable polyurethane dispersion according to claim 1, comprising
a) 20 to 80 wt. % of at least one hydroxy-functional aromatic polyester with an average OH functionality of 1.75 to 3 produced from terephthalic acid,
b) 0.7 to 9 wt. % of at least one isocyanate-reactive hydrophilising agent, which has at least one acid group and at least one group which is reactive towards isocyanate groups,
c) 15 to 60 wt. % of at least one, at least bifunctional polyisocyanate,
d) 2 to 30 wt. % of at least one blocking agent which is reactive towards NCO groups and
e) 0 to 40 wt. % other components,
the percentages a) to e) adding up to 100%.

3. A cross-linkable polyurethane dispersion according to claim 1, comprising containing at least one polyester a), which is a reaction product of
a1) terephthalic acid and optionally at least one additional aromatic di- and/or tricarboxylic acid or anhydride thereof,
a2) at least one diol,
a3) optionally one or more additional components optionally comprising triols, tetraols, monofunctional alcohols, monocarboxylic acids, monoepoxides, bisepoxides, polyepoxides, lactones and/or aliphatic or cycloaliphatic di- or tricarboxylic acids or anhydrides thereof,
wherein the proportion of component a1) in the quantity of components a1) to a3) at least 38 wt. %

4. A cross-linkable polyurethane dispersion according to claim 1, comprising as component a) at least one polyester with a hydroxyl value of 10 to 230 mg KOH/g substance, which is a reaction product of
a1) 38 to 72 wt. % of a mixture of terephthalic acid and optionally at least one additional aromatic di- and/or tricarboxylic acid or anhydride thereof,
a2) 20 to 55 wt. % of at least one diol,
a3) 0 to 40 wt. % of additional components comprising one or more of triols, tetraols, monofunctional alcohols, monocarboxylic acids, monoepoxides, bisepoxides, polyepoxides, lactones, aliphatic or cycloaliphatic di- or tricarboxylic acids or anhydrides thereof,
wherein in the quantity of components a1) used, at least 15 wt. % terephthalic acid is contained.

5. A cross-linkable polyurethane dispersion according to claim 1, wherein component a) comprises a polyester, the glass transition temperature of which is >5° C.

6. A cross-linkable polyurethane dispersion according to claim 1, wherein hydrophilising agent b) comprises hydroxypivalic acid and/or 6-aminohexanoic acid.

7. A cross-linkable polyurethane dispersion according to claim 1, wherein an additional component anhydride-functional hydrophilising agent e) is contained.

8. A cross-linkable polyurethane dispersion according to claim 1, wherein component c) comprises a polyisocyanate component which comprises
62 to 100 wt. % of hexamethylene diisocyanate and/or polyisocyanates based on hexamethylene diisocyanate with uretdione, isocyanurate, urethane, allophanate, biuret, carbodiimide, imino [symbol] oxadiazinedione and/or oxadiazine-trione structures and 0 to 38 wt. % of at least one compound selected from the group consisting of isophorone diisocyanate, 4,4′-diisocyanatodicyclohexyl [symbol] methane, 1-methyl-2,4-diisocyanatocyclohexane, 1-methyl-2,6-diisocyanato [symbol] cyclohexane, 2,4-diisocyanatotoluene and/or 2,6-diisocyanatotoluene.

9. A cross-linkable polyurethane dispersion according to claim 1, comprising a reaction product of
a) 30 to 65 wt. % of a hydroxy-functional aromatic polyester with an average OH functionality of 1.9 to 2.75, a molecular weight Mw of 900 to 3000 g/mol and an acid value of 0.5 to 5 mg KOH/g substance, comprising
a1) 38 to 72 wt. % terephthalic acid and optionally isophthalic acid and/or phthalic anhydride, wherein a1) comprises at least 40 wt. % terephthalic acid,
a2) 20 to 55 wt. % of at least one compound selected from the group consisting of neopentyl glycol, ethylene glycol, propylene glycol, butanediol, diethylene glycol and hexanediol and
a3) 0 to 10 wt. % of at least one compound selected from the group consisting of adipic acid, castor oil, glycerol and trimethylolpropane,
b) 1 to 6 wt. % hydroxypivalic acid,
c) 30 to 50 wt. % of at least one, at least bifunctional polyisocyanate containing hexamethylene diisocyanate,
d) 4 to 18 wt. % at least one compound selected from the group consisting of dimethylpyrazole, butanone oxime and caprolactam,
e) 0 to 20 wt. % of at least one compound selected from the group consisting of trimellitic anhydride, monohydroxy-functional hydrophilic polyethers, hydroxy-functional polyesters, hydroxy-functional C2, C3, C4 polyethers, hydroxy-functional polycarbonates, ethylenediamine, isophorone diamine, diethanolamine, N-methylethanolamine, hydroxyethylethylenediamine, hydrazine, hydrazine hydrate, diethylenetriamine, stearyl alcohol and benzyl alcohol,
the percentages a) to e) and a1) to a3) adding up to 100% in each case.

10. A coating composition comprising an aqueous polyurethane dispersion according to claim 1.

11. A coating composition according to claim 10, selected from the group consisting of paints, lacquers and adhesives.

12. A process for coating a substrate, comprising using the coating composition according to claim 10 to coat said substrate.

13. The process according to claim 12, wherein a vehicle body and/or part of a vehicle body is coated with a coating composition according to claim 10.

14. A substrate comprising coating which comprises the coating composition according to claim 10.

15. The substrate according to claim 14, wherein the substrate is a complete vehicle body and/or part of a vehicle body.

16. The process according to claim 12, wherein said coating composition is selected from the group consisting of paints, lacquers and adhesives.
